(19) United States
(12) Patent Application Publication
(10) Pub. No.: US 2010/0328167 A1
(43) Pub. Date: Dec. 30, 2010

(54) APPARATUS AND SYSTEMS FOR HEATING A SATELLITE ANTENNA REFLECTOR

(75) Inventor: Mark Benedict Stephens, East Morton (GB)

Correspondence Address: EchoStar Technologies, L.L.C.;Legal Department, 9601 SOUTH MERIDIAN BOULEVARD, ENGLEWOOD, CO, 80112, US

(73) Assignee: Eldon Technology Limited, Steeton (GB)

(21) Appl. No.: 12/492,038

(22) Filed: Jun. 25, 2009

(51) Int. Cl. H01Q 1/02

(52) U.S. Cl. 343/704

(57) ABSTRACT

Apparatus and systems are described herein for heating a satellite antenna reflector to remove snow and ice from the reflector surface. A satellite heating system includes a heating element attached to the satellite antenna reflector and a battery associated with the heating element. A satellite receiver provides a satellite antenna with a supply voltage over cabling communicatively coupling the satellite receiver and the satellite antenna. The supply voltage is further utilized to charge the battery. The heating element may then utilize the power supplied by the battery to heat the surface of the reflector, removing ice and snow from the reflector surface.

### BACKGROUND

Many people receive their television programming today via satellite broadcast services. Typically, the consumer has a small satellite antenna mounted on the roof of their home that receives a signal from a geosynchronous satellite. The satellite antenna is connected to a set-top box in the home via coaxial cabling and receives signals from the satellite antenna via the cabling. The set-top box processes the signals and outputs programming to an associated television for viewing by the user.

A problem arises when snow or ice accumulates on the satellite antenna reflector associated with the satellite antenna. Accumulated snow or ice interferes with the reception of signals by the satellite antenna. The interference may be so great than the user is unable to watch television programming while the snow and ice are still present on the satellite antenna reflector. One solution is for the user to physically remove the snow from the satellite antenna reflector, often using a broom, stick or other long object. This option is inconvenient for the user and can be potentially dangerous if the user falls on ice during the removal process.

### BRIEF DESCRIPTION OF THE DRAWINGS

The same number represents the same element or same type of element in all drawings.

FIG. 1 illustrates an embodiment of a satellite broadcast system.

FIG. 2 illustrates an embodiment of a satellite dish of FIG. 1.

FIG. 3 illustrates a circuit diagram of an embodiment of a satellite dish heating system.

FIG. 4 illustrates a block diagram of an embodiment of the satellite dish of FIG. 1.

FIG. 5 illustrates an embodiment of a process for heating a satellite antenna reflector.

### DETAILED DESCRIPTION

Described herein are systems, methods and apparatus for heating a satellite antenna reflector to remove snow and ice from the reflector surface. A satellite heating system includes a heating element attached to the satellite antenna reflector and a battery associated with the heating element. A satellite receiver provides a satellite antenna with a supply voltage over cabling communicatively coupling the satellite receiver and the satellite antenna. The supply voltage is further utilized to charge the battery. The heating element may then utilize the power supplied by the battery to heat the surface of the reflector, removing ice and snow from the reflector surface.

In at least one embodiment, a satellite dish heating system includes a heating element that attaches to a satellite antenna reflector, a battery and a switch operable to communicatively couple and decouple the heating element and the battery. The satellite dish heating system further includes control logic operable to command the switch to communicatively couple the heating element and the battery. The heating element draws power from the battery to heat the surface of the satellite antenna reflector. Cabling communicatively couples the battery, the control logic and the satellite antenna to a satellite receiver (e.g., inside the home). The satellite antenna exchanges data with the satellite receiver over the cabling and the cabling carries power from the satellite receiver to the battery. The power from the satellite receiver is utilized to operate the satellite antenna and charge the battery. In at least one embodiment, the battery is configured to trickle charge using the power from the satellite receiver.

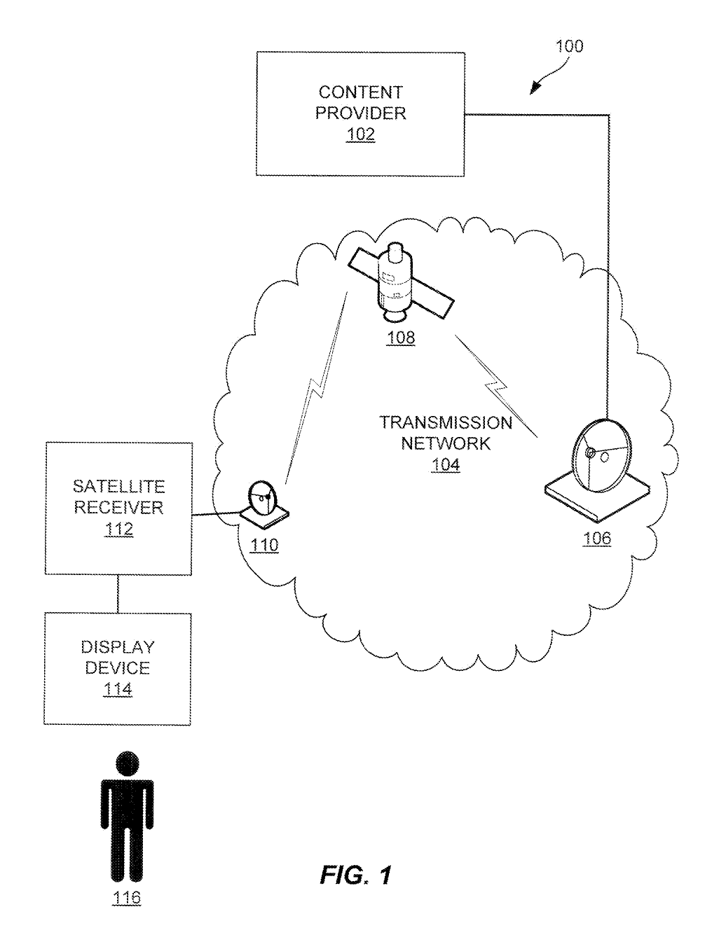

FIG. 1 illustrates an embodiment of a satellite broadcast system 100. The satellite broadcast system 100 includes a content provider 102, a transmission network 104 and a satellite receiver 112 and a display device 114. The transmission network 104 includes an uplink system 106, a satellite 108 and a satellite dish 110. Each of these components will be discussed in greater detail below. The satellite broadcast system 100 may include other elements, components or devices not illustrated for the sake of brevity.

Satellite broadcast system 100 includes a content provider 102 in signal communication with an uplink system 106 of a transmission network 104. The content provider 102 provides the uplink system 106 with television programs that are transmitted to the satellite receiver 112. More particularly, the satellite broadcast system 100 further comprises a satellite 108 in signal communication with the uplink system 106. The satellite 108 broadcasts television programs received from the uplink system 106. A satellite dish 110 receives the television program broadcast from the satellite 108. The satellite dish 110 is in signal communication with the satellite receiver 112 and provides the satellite receiver 112 with the television program. The broadcast television program content is received by the satellite receiver 112 and output for presentation by the display device 114 for viewing by the user 116.

The satellite dish 110 includes a satellite antenna and a satellite antenna reflector. The satellite antenna reflector collects signals and reflects the signals toward the satellite antenna. The satellite antenna receives the signals and transmits the signals to the satellite receiver 112 for further processing. The satellite antenna reflector may be embodied as a parabolic shaped reflector, which is often known as a satellite dish or simply a dish. In at least one embodiment, the satellite antenna is embodied as a low noise block feedhorn (LNBF) converter which receives a signal from the satellite 108 and downconverts the signal for transmission to the satellite receiver 112 through the coaxial cable. The satellite receiver 112 then processes the signal to extract selected programming for output to the display device 114.

In at least one embodiment, the satellite dish 110 and the satellite receiver 112 exchange command signals in an appropriate format, such as digital satellite equipment control (DiSEqC) command signals. DiSEqC is a bi-directional communication protocol between a satellite dish 110 and a satellite receiver 112. The satellite dish 110 further receives a DC power supply from the satellite receiver 112 via the cabling running therebetween. The satellite dish 110 utilizes the DC power supply to power the components of the satellite dish 110.

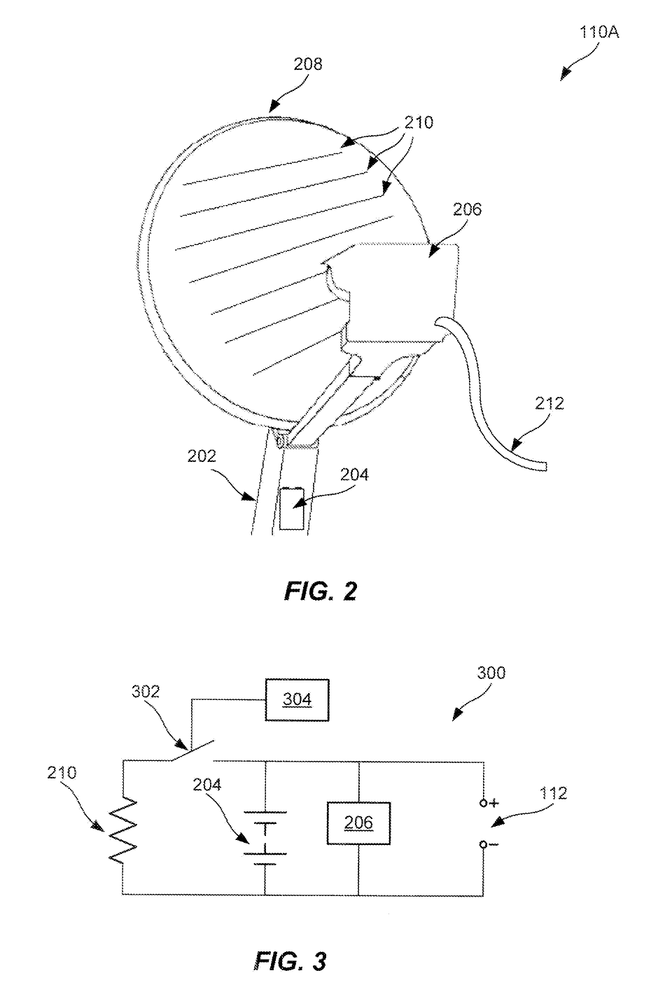

As described above, ice and snow accumulation on the satellite dish 110 may interfere with the reception of signals by the satellite dish 110. To remedy this problem, a heating element may be attached to the satellite dish 110 in order to remove snow and ice accumulation. FIG. 2 illustrates an embodiment of a satellite dish of FIG. 1. The satellite dish 110A includes a mounting mast 202, a battery 204, a satellite antenna 206, a satellite antenna reflector 208, heating elements 210 and coaxial cable 212. Each of these components is discussed in greater detail below. The satellite dish 110A may include other components, elements or devices not illustrated for the sake of brevity.

The mounting mast 202 is operable to mount the satellite dish 110A to a structure. In at least one embodiment, the mounting mast 202 attaches to the roof or a wall of a structure. In other embodiments, the mounting mast 202 may mount to a railing or pole on or near the structure. The mounting mast 202 may be made of any appropriate material, such as metal, selected to hold the satellite dish 110A in place during extreme weather conditions.

The battery 204 is operable to store DC power received from the satellite receiver 112 (see FIG. 1) through the coaxial cable 212. The battery 204 may be communicatively coupled to the coaxial cable 212 through the LNBF, a power control circuit, control logic and the like to receive the DC power supplied by the satellite receiver 112. The battery 204 may be mounted in any appropriate location proximate the satellite dish 110A. In at least one embodiment, the battery 204 may be mounted to selected components of the satellite dish 110A. As illustrated in FIG. 2, the battery 204 may be mounted on the mounting mast 202. However, the battery 204 may also be mounted on a surface of the satellite reflector 208, on a surface of the satellite antenna 206 or any other locations on or near the satellite dish 110A.

The satellite antenna reflector 208 is a parabolic shaped reflector operable to collect signals from the satellite 108 and redirect the signals towards the satellite antenna 208. The satellite antenna 208 is operable to receive the signals reflected from the satellite antenna reflector 208 and process the signals for transmission to the satellite receiver 112 through the coaxial cable. In at least one embodiment, the satellite antenna 206 is an LNBF operable to receive a signal from the satellite 108 and downconvert the signal for transmission to the satellite receiver 112. As described above, the satellite antenna 206 is powered using a DC supply voltage supplied by the satellite receiver 112 through the coaxial cable 212.

The heating elements 210 are operable to heat the surface of the satellite antenna reflector 208, removing accumulated ice and snow from the surface. In at least one embodiment, the heating elements 210 are heating tape attached to the surface of the satellite antenna reflector 208. In another embodiment, the heating elements 210 may be integrated within the satellite antenna reflector 208, e.g., heating/resistive wires embedded within the surface of the satellite antenna reflector 208.

As described above, the heating elements 210 are powered using energy stored by the battery 204. Control logic (not shown in FIG. 2) of the satellite dish 110A is operable to control the operation of the heating elements 210. In at least one embodiment, a switch (not shown in FIG. 2) may communicatively couple and decouple the battery 204 from the heating elements 210, thus, turning the heating elements 210 on and off as appropriate. The control logic may operate to couple and decouple the battery 204 and the heating elements 210 based on input from the satellite receiver 112 and/or other components of the satellite dish 110A depending on desired design criteria. For example, the user 116 may request to activate the heating elements 210 by providing input to the satellite receiver 112. The satellite receiver 112 may then transmit a request to the satellite dish 110A, via the coaxial cable 212, requesting activation of the heating elements 210. In at least one embodiment, the satellite dish 110A includes a sensor operable to trigger activation of the heating elements 210 without intervention of the user 110. For example, light sensors, temperature sensors and/or moisture sensors may be utilized to trigger activation of the heating elements 210.

FIG. 3 illustrates a circuit diagram of an embodiment of a satellite dish heating system 300. The satellite dish heating system 300 includes a satellite receiver 112, a battery 204, a satellite antenna 206, heating elements 210, a switch 302 and control logic 304. Each of these components is discussed in greater detail below. The satellite dish heating system 300 may include other components not illustrated for the sake of brevity and the further discussion of components common to FIGS. 1-2 is omitted.

The satellite receiver 112 is communicatively coupled to the battery 204 and the satellite antenna 206. The satellite receiver 112 may optionally be communicatively coupled to the control logic 304. The coupling of the control logic 304 and the satellite receiver 112 is not shown in FIG. 3. The satellite receiver 112 provides a DC power supply to the battery 204 and the satellite antenna 206 as illustrated in FIG. 3. The DC power supply may also power the control logic 304. Other information, such as television programming and control commands may also be exchanged between the satellite receiver 112 and the control logic 304 and/or the satellite antenna 206 over the same coaxial cable carrying the DC power supply.

The battery 204 is charged using the DC power supply provided by the satellite receiver 112. For example, a 12 V supply of at least 500 mA may be available in one embodiment utilizing the DiSEqC standard for communicating from the satellite receiver 112 to the satellite dish 110A. In some embodiments, the satellite dish may include other equipment, such as solar or wind powered electrical generators may be utilize to augment the power utilized to charge the battery 204.

A switch 302 couples and decouples the heating elements 210 from the battery 204. The switch 302 is controlled by commands from the control logic 304. When the switch 302 is closed, the heating elements 210 are coupled to the battery 204 and emit heat, which melts ice or snow accumulated on the surface of the satellite antenna reflector 208 (see FIG. 2). The heating elements 210 may be entirely powered by the battery 204 or may be powered by a combination of the stored energy in the battery 204 and the DC power supplied by the satellite receiver 112.

Because the heating elements 210 are not entirely powered by the DC power supplied by the satellite receiver 112, there is sufficient energy available to continue powering the satellite antenna 206 while the heating elements 210 are activated. Thus, in some situations, the heating elements 210 may be activated while the user 110 (see FIG. 1) continues watching television. This is helpful for example to begin melting snow on the satellite antenna reflector 208 (see FIG. 2) before enough snow accumulates to significantly interfere with the reception of signals by the satellite antenna 206.

In at least one embodiment, the battery 204 may then be trickle charged using a portion of the DC power supplied by the satellite receiver 112. For example, the battery 204 may be charged using a portion of the DC power as the user 110 (see FIG. 1) watches television, while enough energy is still available to operate the satellite antenna 206 simultaneously. Further, because the heating elements 210 are powered by stored energy in the battery 210, the coaxial cable 212 (see FIG. 2) is not overloaded by trying to supply the appropriate amount of power to run the heating elements 210 in real time.

One problem with utilizing solely available DC power supply from the cable 212 is that there may not be a sufficient amount of energy to heat up the satellite reflector 208 and snow enough to melt the snow. This converts cold snow into less cold snow as the heat is radiated and conducted away from the heating elements 210 as fast as the energy is discharged into the heating elements 210. Thus, the snow is not effectively melted. By utilizing the charged battery 204 to power the heating elements 210, the power is discharged from the battery 210 in a controlled manner. Thus, it is possible to raise the temperature of the reflector 208 to melt at least some snow before the battery 204 is completely discharged. Thus, in at least one embodiment, the battery 204 may be recharged and multiple discharged cycles may be utilized to eventually melt away the desired amount of snow/ice.

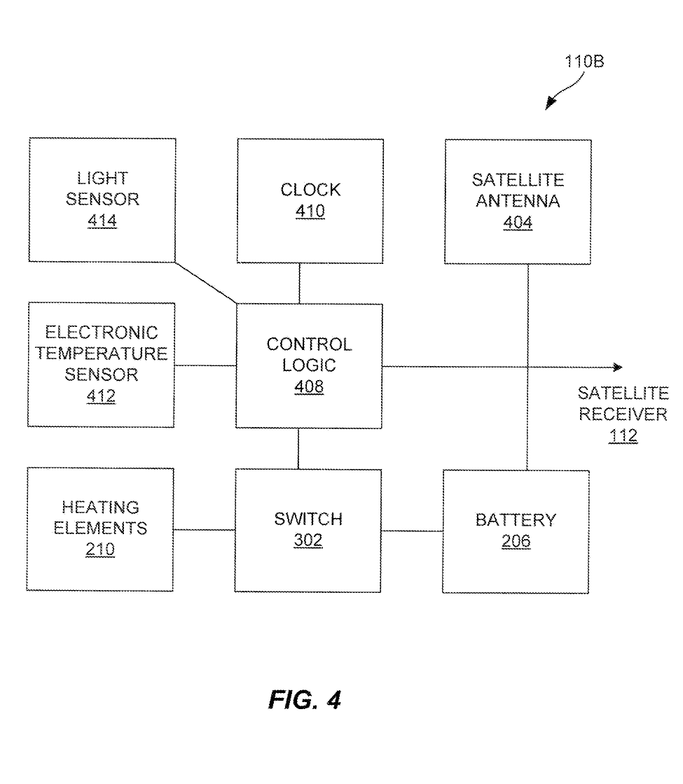

FIG. 4 illustrates a block diagram of an embodiment of the satellite dish of FIG. 1. The satellite dish 110B includes a battery 206, heating elements 210, a switch 302, a satellite antenna 404, control logic 408, a clock 410, an electronic temperature sensor 412 and a light sensor 414. Each of these components is discussed in greater detail below. The satellite dish 110B may include other components, elements or devices not illustrated for the sake of brevity. The further discussion of components common to FIGS. 1-3 is omitted herein.

The battery 206, the satellite antenna 404 and the control logic 408 are communicatively coupled to the satellite receiver 112 through appropriate cabling, such as coaxial cable. Each component receives power from the satellite receiver 112. The battery 206 utilizes the received power for charging purposes as described above. In at least one embodiment, the control logic 408 is operable to control the charging of the battery 206. The satellite antenna 404 and the control logic 408 operate using the power supplied by the satellite receiver 112.

The satellite antenna 404 and the control logic 408 are further operable to exchange information with the satellite receiver 112 as described above. For example, the satellite receiver 112 may transmit a request to the control logic 408 to activate the heating elements 210.

The switch 302 is operable to communicatively couple the heating elements 210 and the battery 206, activating the heating elements 210. The switch 302 operates to couple the battery 206 and the heating elements 210 based on a command from the control logic 408. Similarly, the switch 302 may decouple the heating elements 210 and the battery 206 based on a similar command.

The electronic temperature sensor 412 is operable to measure the temperature of the ambient air surrounding a satellite antenna reflector (not shown in FIG. 4) of the satellite dish 112B. Examples of electronic temperature sensors include thermistors, thermocouples and integrated circuit semiconductor bandgap temperature sensors. However, it is to be appreciated that other types of electronic temperature sensor may also be utilized. The light sensor 414 is operable to detect whether snow or ice are present on the surface of a satellite antenna reflector. The light sensor 414 may comprise an infra-red sensor or other type of appropriate sensor for detecting the presence of snow or ice.

In at least one embodiment, a sensor may be utilized that detects changes in albedo of the reflector 208 surface rather than by occlusion of daylight due to snow cover. For example, the sensor may detect the ratio of ambient light to light reflected from the surface of the reflector 208. In at least one embodiment, the ratio may then be utilized to differentiate between fresh white snow and a dull matte surface of a reflector 208 or a mesh surface reflector 208.

The clock 410 is operable to maintain a real time clock utilized to track the time of day. The clock 410 may comprise any type of appropriate circuitry for maintaining time. In at least one embodiment, the clock 410 may periodically synchronize its time with the satellite receiver 112 (see FIG. 1). The clock 410 may be embodied within the control logic 408 or may comprise separate circuitry depending on desired design criteria.

The control logic 408 is operable to control the operation of the satellite dish 110B. The control logic 408 may be a single processing device or a plurality of processing devices that cooperatively operate to control the operation of the control logic 408. In at least one embodiment, the control logic 408 is integrated within the satellite antenna 404.

The control logic 408 is operable to determine when to activate the heating elements 210 and command the switch accordingly to couple/decouple the battery 206 and the heating elements 210. For example, the control logic 408 may receive input from the satellite receiver 112 requesting activation of the heating elements 210. The control logic 408 responsively commands the switch 302 to couple the heating elements 210 and the battery 206.

In at least one embodiment, the control logic 408 is operable to automatically determine when snow is present on the satellite antenna reflector and activate the heating elements 210 accordingly. For example, the control logic 408 may process input from the light sensor 414 indicating that there is snow/ice present on the satellite antenna reflector. The control logic 408 responsively activates the heating elements 210 by closing the switch 302. The control logic 408 may continue to process input from the light sensor 414 to determine when the snow/ice has been removed and then may responsively deactivate the heating elements 210 by opening the switch 302.

In some embodiments, the control logic 408 may be operable to process additional inputs to determine whether to activate the heating elements. For example, the control logic 408 may process a time of day, provided by the clock 410, as well as a light level from the light sensor 414, to determine whether the sun should be shining at the particular time. Thus, the control logic 408 may not activate the heating elements 210 during night time if the light sensor 414 is merely detecting an absence of sunlight due to the nighttime, rather than an absence of light because of ice/snow accumulation on the satellite antenna reflector.

Similarly, the control logic 408 may be operable to process a temperature input from the electronic temperature sensor 412 in association with input from the light sensor 414 to determine whether to activate the heating elements 210. For example, the electronic temperature sensor 412 measurements may indicate a temperature of 70 degrees and the light sensor 414 input to the control logic 408 may indicate an absence of light. Because of the relatively high temperature, it is unlikely that snow/ice have accumulated on the surface of the satellite antenna reflector. Rather, the lack of light measured by the light sensor 414 is more likely due to the night time hours. Thus, the control logic 408 may make a decision to not activate the heating elements 210 based on processing of the two inputs. There are many different rules that may be applied to process the inputs of the clock 410, the electronic temperature sensor 412 and the light sensor 414 to determine whether to activate the heating elements 210 depending on desired design criteria.

Because the satellite dish heating system receives power through the cabling, advantageously there is no need for separate power cables or outlets to supply power for the heating system. Additionally, the snow melting system can be installed during manufacture of the reception system to avoid the need for additional onsite installation work. Further, the battery is trickle charged, so the power supply to the LNB is not overloaded during peak power requirement periods. In at least one embodiment, the effectiveness of the snow melting process may be optimized by regulating the battery energy discharged into the heating elements to ensure sufficient rise in temperature from the freezing point. This successfully heats the snow into water without heating the dish to a higher temperature than necessary. In embodiments including sensor elements, the presence of snow/ice may be automatically detected to maximize the effectiveness of the heating system.

In at least one embodiment, different areas of the reflector 208 may be heated up at varying times. This allows for the creation of paths for the meltwater to runaway from the surface of the reflector 208. The control logic 408 may control the discharge of energy into different heating elements 210 at varying times, first creating the meltwater pathways and then melting the remaining snow on the surface of the reflector, which runs off the reflector 208 through the pathways. The light sensor 414 and/or the electronic temperature sensor 412 may be utilized to monitor the meltwater pathways. In at least one embodiment, if a pathway becomes blocked, then the control logic 408 may control the heating elements 210 to unblock the pathway before returning to melt other snow on the surface of the reflector 208.

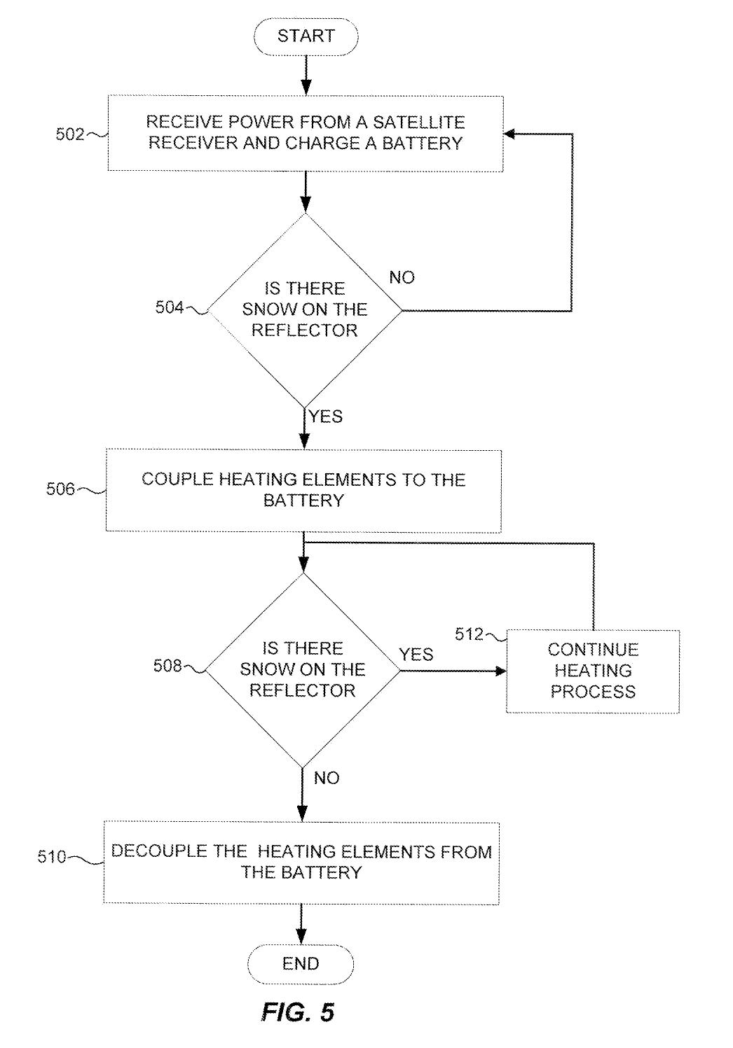

FIG. 5 illustrates an embodiment of a process for heating a satellite antenna reflector. The process of FIG. 5 may include other operations not illustrated for the sake of brevity.

The process includes receiving power from a satellite receiver and charging a battery located proximate a satellite antenna reflector using the supplied power (operation 502). The process further includes identifying whether snow or ice have accumulated on the surface of the satellite antenna reflector (operation 504). The identifying operation may be performed by processing a request from a satellite receiver or may be determined based on measurements of various sensors, such as an electronic temperature sensor or a light sensor.

If operation 504 results in an identification that snow/ice are present on the satellite antenna reflector, then the process further includes coupling heating elements to the battery (operation 506). The heating elements are operable to emit heat, melting the snow/ice from the surface of the satellite antenna reflector. In at least one embodiment, when the battery is coupled to the heating elements the regulation of power is determined by an active regulation method, such as pulse width modulation (PWM). The active regulation method may be regulated by the temperature sensor to ensure a sufficient temperature rise to melt the snow without using excessive energy. If operation 504 results in identification that snow/ice is not present on the satellite antenna reflector, then the process reverts back to charging operation 502 (if appropriate), until such time that snow/ice is present on the satellite antenna reflector.

The process further includes identifying whether the snow/ice has been removed the surface of the satellite antenna reflector (operation 508). For example, input may be received from the satellite receiver requesting to deactivate the heating elements. In at least one embodiment, input from sensors may be utilized to detect when the snow/ice has been removed, similar to operation 504. If operation 508 results in a determination that the snow/ice has been removed from the surface of the satellite antenna reflector, then the process further includes decoupling the battery from the heating elements (operation 510). If operation 508 results in a determination that the snow/ice is still present on the surface of the satellite antenna reflector, then heating process continues (operation 512) until the snow/ice has been removed. Thus, through the process of FIG. 5, snow/ice accumulation which may interfere with signal reception may be removed from the surface of satellite antenna reflector.

Although specific embodiments were described herein, the scope of the invention is not limited to those specific embodiments. The scope of the invention is defined by the following claims and any equivalents therein.

What is claimed is:

1. A satellite dish heating system comprising:
a heating element that attaches to a satellite antenna reflector;
a battery;
a switch operable to communicatively couple and decouple the heating element and the battery;
control logic operable to command the switch to communicatively couple the heating element and the battery, the heating element drawing power from the battery to heat the surface of the satellite antenna reflector; and
cabling communicatively coupling the battery, the control logic and a satellite antenna to a satellite receiver, the satellite antenna exchanging signals with the satellite receiver over the cabling, the cabling further carrying power from the satellite receiver to the battery, the satellite antenna and the control logic, the battery operable to trickle charge using the power supplied by the satellite receiver.

2. The satellite dish heating system of claim 1, wherein the battery is attached to the satellite antenna reflector.

3. The satellite dish heating system of claim 1, wherein the battery is attached to a mounting mast for the satellite antenna reflector.

4. The satellite dish heating system of claim 1, wherein the control logic is further operable to receive a request from the satellite receiver requesting heating of the satellite antenna reflector, the control logic operable to command the switch to communicatively couple the heating element and the battery responsive to the request.

5. The satellite dish heating system of claim 1, further comprising:
a sensor operable to detect snow and ice on the surface of the satellite antenna reflector;
the control logic operable to command the switch to communicatively couple the heating element and the battery based on input from the sensor.

6. The satellite dish heating system of claim 5, wherein the sensor comprises a light sensor.

7. The satellite dish heating system of claim 6, further comprising an electronic temperature sensor operable to detect a temperature of the ambient air around the satellite antenna reflector, the control logic further operable to command the switch to communicatively couple the heating element and the battery based on the temperature.

8. The satellite dish heating system of claim 6, wherein the control logic is further operable to command the switch to communicatively couple the heating element and the battery based on a time of day.

9. The satellite dish heating system of claim 1, wherein the heating element comprises heating tape attached to a surface of the satellite antenna reflector.

10. The satellite dish heating system of claim 9, wherein the heating element comprises heating wires embedded within the satellite antenna reflector.

11. A system comprising:
a satellite antenna reflector;
a satellite antenna operable to receive a signal reflected from the satellite antenna reflector;
a heating element that attaches to the satellite antenna reflector;
a battery mounted proximate the satellite antenna reflector;
a switch operable to communicatively couple and decouple the heating element and the battery;
control logic operable to command the switch to communicatively couple the heating element and the battery, the heating element drawing power from the battery to heat the surface of the satellite antenna reflector; and
cabling communicatively coupling the battery, the control logic and a satellite antenna to a satellite receiver, the satellite antenna exchanging information with the satellite receiver over the cabling based on the signal, the cabling further carrying power from the satellite receiver to the battery, the satellite antenna and the control logic, the battery operable to trickle charge using the power supplied by the satellite receiver.

12. The system of claim 11, wherein the battery is attached to the satellite antenna reflector or a mounting mast for the satellite antenna reflector.

13. The system of claim 11, wherein the control logic is further operable to receive a request from the satellite receiver to heat the satellite antenna reflector, the control logic operable to command the switch to communicatively couple the heating element and the battery responsive to the request.

14. The system of claim 11, further comprising:
a light sensor operable to detect snow and ice on the surface of the satellite antenna reflector;
the control logic operable to command the switch to communicatively couple the heating element and the battery based on input from the sensor.

15. The system of claim 14, further comprising an electronic temperature sensor operable to detect a temperature of the ambient air around the satellite antenna reflector, the control logic further operable to command the switch to communicatively couple the heating element and the battery based on the temperature.

16. The system of claim 14, wherein the control logic is further operable to command the switch to communicatively couple the heating element and the battery based on a time of day.

17. The system of claim 11, wherein the heating element comprises heating tape attached to a surface of the satellite antenna reflector.

18. The system of claim 11, wherein the heating element comprises heating wires embedded within the satellite antenna reflector.

19. A satellite dish heating system comprising:
a heating element that attaches to a satellite antenna reflector;
a battery;
a switch operable to communicatively couple and decouple the heating element and the battery;
a light sensor operable to detect snow and ice on the surface of the satellite antenna reflector;
an electronic temperature sensor operable to detect a temperature of the ambient air around the satellite antenna reflector;
a clock;
control logic operable to command the switch to communicatively couple the heating element and the battery based on input from the light sensor and at least one of the electronic temperature sensor and the clock, the heating element drawing power from the battery to heat the surface of the satellite antenna reflector; and
cabling communicatively coupling the battery, the control logic and a satellite antenna to a satellite receiver, the satellite antenna exchanging signals with the satellite receiver over the cabling, the cabling further carrying power from the satellite receiver to the battery, the satellite antenna and the control logic, the battery operable to trickle charge using the power supplied by the satellite receiver.

20. The satellite dish heating system of claim 19, wherein the control logic is integrated with the satellite antenna.
